(19) United States
(12) Patent Application Publication
(10) Pub. No.: US 2007/0215276 A1
(43) Pub. Date: Sep. 20, 2007

(54) Method and apparatus for removing a plastic film from packages

(75) Inventor: Marek Sieredzinski, Radom (PL)

Correspondence Address: NIXON & VANDERHYE, PC, 901 NORTH GLEBE ROAD, 11TH FLOOR, ARLINGTON, VA, 22203, US

(73) Assignee: International Tobacco Machinery Poland Ltd., Radom (PL)

(21) Appl. No.: 11/724,245

(22) Filed: Mar. 15, 2007

(30) Foreign Application Priority Data
Mar. 17, 2006 (PL) P 379221

(51) Int. Cl. B29C 63/00

(52) U.S. Cl. 156/344; 156/584

(57) ABSTRACT

Present invention relates to the method and apparatus for removing a plastic film from packages, where packages covered by the plastic film are introduced to the first transport path characterized in that an sorbent (12) is introduced to the second transport path. Next the sorbent (12) is heated to the flow temperature of the plastic that is removed, in particular plastics from the polyolefin's group. Afterwards within the common part of the first and second transport path (2) of the separating device the sorbent (12) is mixed with transported packages (11) covered with a plastic film. A sieve (8) of the separating device directs sorbent (12) covered by absorbed plastic to the removing path (6,9), while packages (11) free from plastic film are directed towards the exit gate (4) of the separating device.

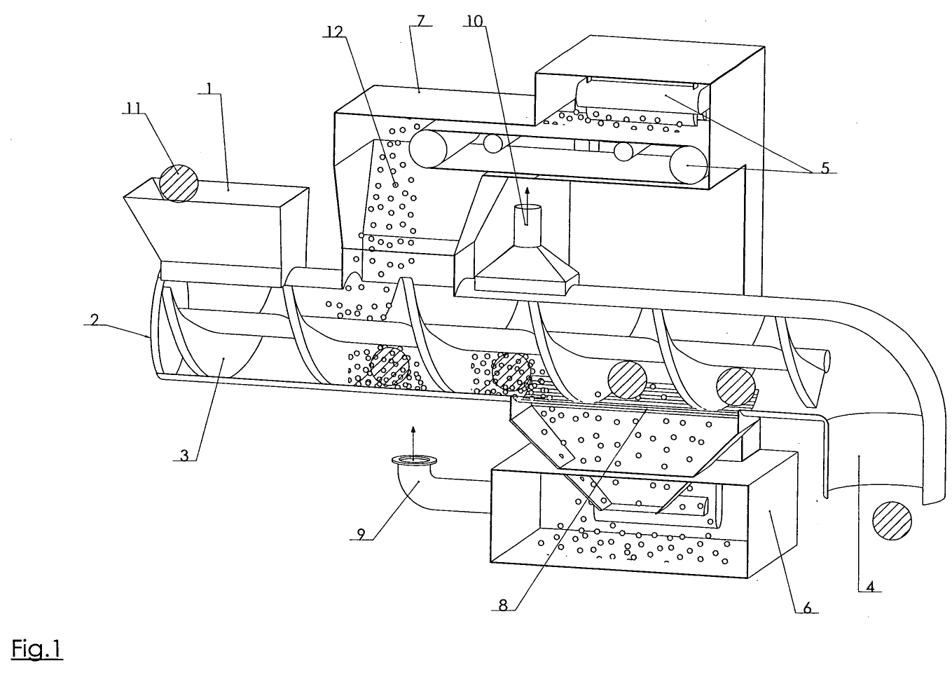

### BACKGROUND OF THE INVENTION

In the industrial process of packaged products production, packaging is usually made of cardboard (cellulose) covered with printer's ink or/and other protective and/or decorative coatings. The next step in the production chain is covering the packaged product with a plastic film, for example covering a closed package of cigarettes, herbs, tea or sweets with a plastic film. In practical applications films made of plastics from the polyolefin group are used, for example films made of polypropylene. Due to requirements of the industry uniform films (made of one material/plastic) and multi-layered films including composite films, where separate films are made of materials of different physical and chemical properties, are used.

### SUMMARY OF THE INVENTION

From the technological and/or marketing reasons there might be necessary to reject a part or whole series of products. One of the reasons for this can be failure to pass quality test in a case of the final product or expiration of the validity date.

In a case of the products rejected or returned to producer, it is preferable to recycle main ingredient of the product which is inside packages. In a case of the cigarettes boxes this is a tobacco being inside the cigarettes. To extract this ingredient it is necessary to remove a plastic film covering the packages first, next it is necessary to remove intermediate packaging, for example made of cardboard, and finally completely separate this packaging from the products being inside. Removing a plastic film from the packages is performed independently in respect to the operation of opening the cardboard packaging. This is in order to keep the main product in a complete separation from the particles of a plastic film.

The most difficult step in the above described procedure is removing a plastic film from a package. In the process of removing a plastic film it is important to remove a film completely and not to contaminate the main product present within the package neither chemically for example by vapors products of not complete combustion and/or pyrolysis of the film, nor by thermal and/or mechanical degradation, nor by mechanical contamination that make recycling the main product impossible.

The main obstacle when removing a plastic film made of polyolefines, for example with a polypropylene, is constituted by their mechanical properties, including high shear resistance and braking resistance as well as chemical resistance for solvents. Due to amorphous structure, a plastic film covering products under mechanical processing, for example cutting and/or tearing, brakes along non regular lines often with a sharp edges, this leads to creation of inclusion of the small particles of a plastic film in the main product being recycled. The particles can get to the main stream of the main product and contaminate this product which makes further recycling of a main product impossible.

Within the state of the art, there are known solutions to the problem of removing a plastic film, however state of the art solutions are using usually mechanical solutions, for example cutting a plastic film.

U.S. Pat. No. 5,476,354 discloses a method and apparatus for opening a soft cigarette boxes. Apparatus according to this invention removes a plastic covering a box by cutting the top part of the box. Next the cut off parts of the box are removed by appropriate transport means.

A device for removing a plastic films is a subject of the US patent application No. 2004/0250670 A1.

This device for removing comprises a cutting section which is provided with a heated cutting element. This device is also based on the principle of using cutting elements and removing cut off parts of the packages.

The main objective of the present invention is to provide a method and apparatus for removing a plastic film from a package, while keeping a main product inside a package not contaminated by the particles of the plastic film, not contaminated chemically and not destroyed by a rapid mechanical process.

According to the invention it is provided a method for removing a plastic film, where package covered by the plastic film is introduced into the first transport path characterized in that sorbent is introduced into the second transport path, further the sorbent is heated to the flow temperature of the plastic that is removed, in particular plastics from the polyolefin's group, or to the higher temperature. The range of temperature to which the sorbent is heated is selected individually to the product recycled and/or materials of the packages, in particular temperature is selected in respect to physical and chemical properties of the plastic film that needs to be removed from the package. Next within the first common part of the first and second transport paths of the separating device the sorbent is mixed with packages covered with a plastic film, further a sieve of the separating device directs sorbent covered with absorbed plastic to the removing path, while packages free from plastic film are directed towards the exit gate of the separating device.

Preferably method according to the invention is characterized in that a sorbent has a form of granules of the substance that is wetting by molten polyolefines, in particular porous metal particles.

Preferably method according the invention is characterized in that a sorbent has a form of granules, in particular ceramic balls and/or ceramic balls covered with a porous metal layer, of a diameter from 0.5 mm to 50 mm, with maximum porosity.

Preferably method according to the invention is characterized in that a sorbent has a form of rolls with a working surface, i.e. a surface that is in contact with film or package, that is covered with a layer as described above.

Preferably method according to the invention is characterized in that for direct contact with a plastic that is removed a sorbent in a form of polyolefin oxy catalyst is used, in particular a low temperature polyolefin oxy catalyst.

Preferably method according to the invention is characterized in that the material of sorbent is chosen from a group comprising materials having better affinity with a plastic material of plastic film than with a package material.

Further according to the invention there is provided a separating apparatus for removing a plastic film, comprising transport path for transporting objects covered with a plastic film and transport path for transporting a sorbent characterized in that within the transport path for transporting sorbent heating means are provided for heating sorbent to the flow temperature of the plastic material that is removed or to the higher temperature, and both transport paths comprise common part for mixing sorbent with objects covered with a plastic film, the common part of the transport paths comprises separating means for separating sorbent and objects free from a plastic film.

Method according to the invention is particularly preferable in applications which require a dry processing of a main material, i.e. in processes without contact with liquids, and where high purity of the recycled product is required. Method according to the invention is not putting a main product under heavy mechanical conditions, further in the method according to the invention the main product is not contaminated with a chemical product being a side effect of not full combustion nor pyrolyzis. Limiting sorbet's temperature in the common part of the transport path to the range of the flowing temperature of the plastic being separated from package allows safe removing a plastic film from a package.

Preferably sorbent can be recycled itself, when the absorbed material, for example polyolefines, is removed from the sorbent surface and further eliminated from the process, afterwards sorbent can reach appropriate technical process parameters and can be returned to the main process.

Preferably a sorbent is a catalyst with a working temperature i.e. temperature at which a plastic is oxidized, higher than temperature of flowing for example polyolefines/polypropylene of which a film covering a package is made of.

It is particularly preferably when recycling of the sorbent in carried out in a sorbtion phase, when a sorbent is a low temperature oxidation catalyst for polyolefines.

### BRIEF DESCRIPTION OF THE DRAWING

The subject matter of the invention has been described below in a preferable embodiment with relation to the drawing at which device according to the invention has been presented in an isometric view.

In the device presented at the drawing, packages comprising tobacco products (11) and covered with a plastic film are thrown or in other way introduced through an inlet (1). The process part (2) of the device comprises transport means (3) forcing a transport of the packages (11) and sorbent (12) inside the device. In the embodiment presented, the transport means (11) is a feeding screw.

### DETAILED DESCRIPTION OF THE INVENTION

Next, inside the device within the transport unit (2) packages (11) are mixed with a sorbent (12). When the sorbent (12) moves in relation to the packages and due to their movement within the process part (2) of the device forced by the transport unit (3), and due to the better affinity of the plastic with a sorbent than with a package, plastic cover is removed from the packages and is absorbed at the sorbent surface. Sorbent with absorbed plastic film is removed from the device, for example by sieve (8), and transported to the regenerator (6) where the plastic is removed from the granules' surface (sorbent surface) and regeneration of its surface allowing reuse of the sorbent and removing plastic film in a next process cycle. Sorbent granules (12) are further transported by the arrangement of transporting means (5) and returned to the process into the device (2) via inlet and/or dispenser (7)

After separating sorbent granules, packages (11) are transported further and leave the process part of the device (2) through outlet and/or dispenser (4)

When it is necessary inside the regenerator (6) there can be run a pyrolysis of the plastic removed from the packages. The gas exhaust (9) allows control over a working environment inside the device. In the same way gas exhaust (10) allows control and preserving a preferable working environment inside process part (2) of the device.

1. Method for removing a plastic film, where package covered by the plastic film is introduced to the first transport path characterized in that an sorbent (12) is introduced to the second transport path, further the sorbent (12) is heated to the flow temperature of the plastic that is removed, in particular plastics from the polyolefin's group, or to the higher temperature, within the first common part of the first and second transport path (2) of the separating device the sorbent (12) is mixed with packages (11) covered with a plastic film, further a sieve (8) of the separating device directs sorbent (12) covered by absorbed plastic to the removing path (6,9), while packages (11) free from plastic film are directed towards the exit gate (4) of the separating device.

2. Method according to claim 1, characterized in that a sorbent has a form of granules of the substance that is wetting by polyolefines, in particular granules are porous, uniform particles of metal and/or particles of metal placed within ceramic substrate.

3. Method according to claim 1, characterized in that a sorbent has a form of uniform or layered granules, in particular metal balls of a diameter from 0.5 mm to 50 mm.

4. Method according to claim 1, characterized in that a sorbent has a form of rolls with a working surface covered with a layer of a porous metal.

5. Method according to claim 1 characterized in that as a sorbent for direct contact with a plastic that is removed, a polyolefin oxy catalyst is used.

6. Method according to claim 1 characterized in that the material of sorbent is chosen from a group of materials having better affinity with a plastic material of the film being removed than with a package material.

7. Separating apparatus for removing a plastic film comprising transport path for transporting objects covered with a plastic film and transport path for transporting a sorbent characterized in that in the transport path (5, 6, 7, 8) for transporting sorbent (12) heating means are provided for heating sorbent to the flow temperature of the plastic material that is removed or to the higher temperature, and both paths comprise common part for mixing sorbent (12) with objects (11) covered with a plastic film, the common part of the transport paths comprises separating means (8) for separating sorbent and objects free from a plastic film.
